(19) United States
(12) Patent Application Publication
(10) Pub. No.: US 2014/0226907 A1
(43) Pub. Date: Aug. 14, 2014

(54) AUTOMATED DETECTION OF DISTRACTING IMAGES

(71) Applicant: Google Inc., Mountain View, CA (US)

(72) Inventor: David Kosslyn, San Francisco, CA (US)

(73) Assignee: Google Inc., Mountain View, CA (US)

(21) Appl. No.: 13/767,715

(22) Filed: Feb. 14, 2013

(51) Int. Cl. G06K 9/00

(52) U.S. Cl. CPC G06K 9/00456
USPC 382/197; 382/159

(57) ABSTRACT

A system and method are disclosed for detecting when an image provided by a user for inclusion in a web page may be distracting to viewers of the web page. In one implementation, a computer system determines a measure of visual complexity of an image (e.g., a measure based on how often neighboring pixels in the image differ in intensity by at least a given percentage, etc.). The image is then included in a web page only when the determined measure of visual complexity is below a threshold.

### TECHNICAL FIELD

Aspects and implementations of the present disclosure relate to user-provided Web content, and more specifically, to detecting when an image provided by a user for inclusion in a web page may be distracting to viewers of the web page.

### BACKGROUND

Multimedia is becoming pervasive on the World Wide Web. In addition to content providers such as news organizations and media companies providing content on websites, some websites allow users to upload images for inclusion in web pages (e.g., as a background image, within a particular frame or area of the web page, etc.), thereby enabling users to customize and personalize the look and feel of web pages.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a computer system detects when an image provided by a user for inclusion in a web page may be distracting to viewers of the web page. In one implementation, a computer system determines a quantitative measure of visual complexity of an image provided by a user (e.g., a measure based on the number of line segments, the number of line segment crossings, etc.). The image is then included in a web page only when the determined measure of visual complexity is below a threshold.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIGS. 1A and 1B depict two illustrative web page layouts that include user-provided images.

FIG. 2 illustrates an exemplary system architecture, in accordance with one implementation of the present disclosure.

FIG. 3 is a block diagram of one implementation of a web page manager.

FIG. 4 depicts a flow diagram of aspects of a first method for detecting and handling when a user-provided image may be too distracting for inclusion in a web page.

FIG. 5 depicts a flow diagram of aspects of a second method for detecting and handling when a user-provided image may be too distracting for inclusion in a web page.

FIG. 6 depicts a flow diagram of aspects of a first method for determining a measure of visual complexity of an image.

FIG. 7 depicts a flow diagram of aspects of a second method for determining a measure of visual complexity of an image.

FIG. 8 depicts a block diagram of an illustrative computer system operating in accordance with aspects and implementations of the present disclosure.

### DETAILED DESCRIPTION

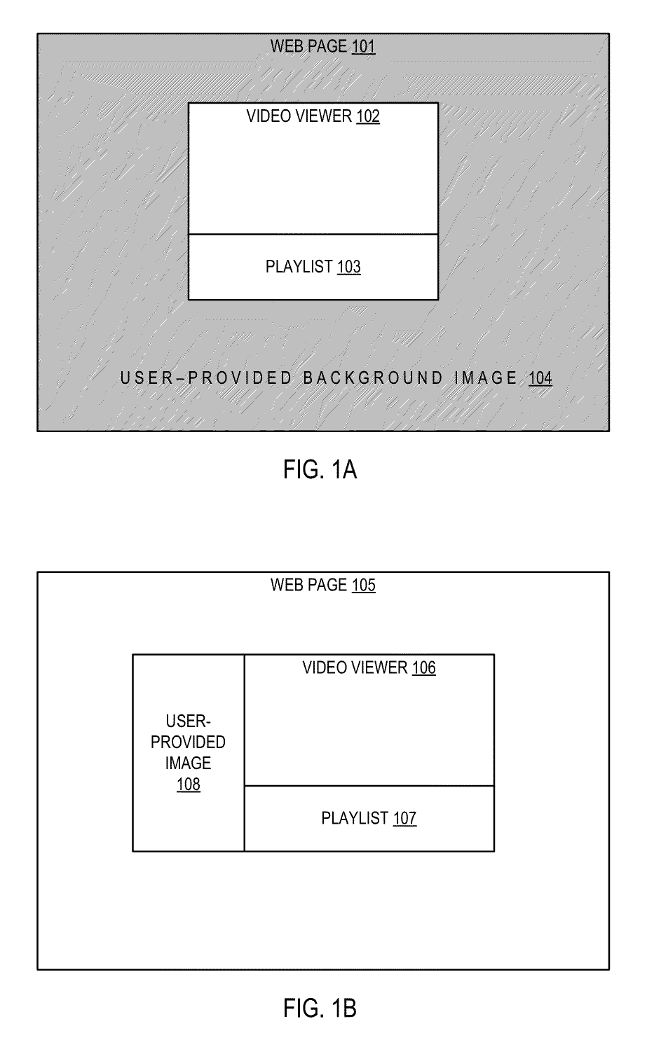

Aspects and implementations of the present disclosure are disclosed for determining when a user-provided image may be too distracting for inclusion in a web page, and handling such situations accordingly. Examples of web pages that include a user-provided image are depicted in FIGS. 1A and 1B. In FIG. 1A, a web page 101 comprises a video viewer area 102 for viewing video clips, a playlist area 103 that lists video clips to be viewed, and a background image 104 provided by a user. In FIG. 1B, a web page 105 comprises video viewer area 106, playlist area 107, and an image 108 provided by a user. It should be noted that the contents and layouts of FIGS. 1A and 1B are merely illustrative, and that in some implementations, web pages 101 and 105 may include other elements that are provided by a user, either in addition to, or instead of, those depicted in the Figures (e.g., video viewer 102 might be replaced with a foreground image provided by a user, etc.).

In a first implementation, a computer system receives an image from a user for inclusion in a web page, and determines a measure of visual complexity of the image. When the measure of visual complexity is below a threshold, the image is included in the web page, otherwise a message is transmitted to the user indicating that the image is potentially distracting to viewers of the web page, and requesting the user to provide a different, simpler image. In a second implementation, the computer system receives, as in the first implementation, an image from a user for inclusion in a web page, and determines a measure of visual complexity of the image. When the measure of visual complexity equals or exceeds the threshold, the computer system transmits, as in the first implementation, a message to the user indicating that the image is potentially distracting to viewers of the web page. However, rather than requesting the user to provide a different image, the message requests permission from the user for the computer system to simplify the image. If such permission is granted, the computer system generates a new version of the image having lower visual complexity and includes the new version of the image in the web page, instead of the original image.

In one implementation, the measure of visual complexity is determined by an image-processing algorithm that applies a high-pass filter to the image and determines the number of various elements in the filtered image (e.g., pixels, line segments, line segment crossings, etc.). The algorithm also compresses the original image, and determines a compression factor for the compressed image. The algorithm then computes the measure of visual complexity as a function of the different numbers of elements in the filtered images (e.g., the number of pixels, the number of line segments, the number of line segment crossings, etc.) and of the compression factor.

In another implementation, the measure of visual complexity is determined by extracting features of the image (e.g., color, texture, intensity, etc.) via image processing techniques and providing a feature vector comprising these features to a classifier (e.g., a support vector machine [SVM], AdaBoost, a neural network, a decision tree, etc.) that has been trained on positive and negative examples of visually complex images. The classifier outputs a score (e.g., a number between 0 and 1 inclusive, etc.) based on the feature vector that reflects how complex the image is, and a measure of visual complexity is obtained from the score.

Aspects and implementations of the present disclosure are thus capable of preventing users from including an image in a web page that may be distracting to other users who view the web page. In addition to improving the user experience for users of the website, this capability can provide a degree of aesthetic consistency among users' customized web pages on the website.

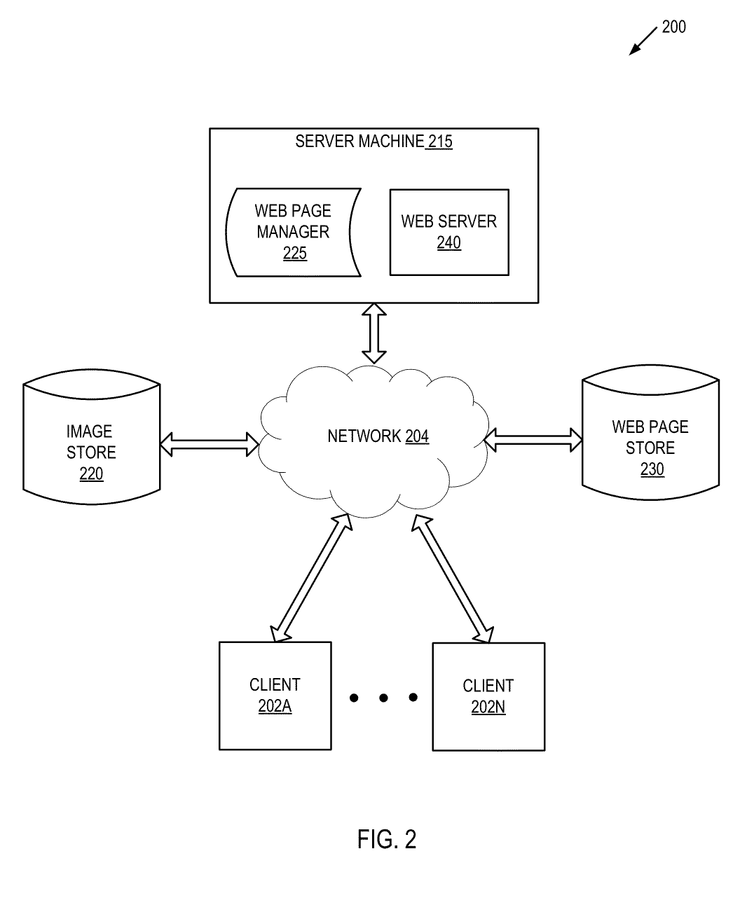

FIG. 2 illustrates an example system architecture 200, in accordance with one implementation of the present disclosure. The system architecture 200 includes a server machine 215, an image store 220, a web page store 230, and client machines 202A-202N connected to a network 204. Network 204 may be a public network (e.g., the Internet), a private network (e.g., a local area network (LAN) or wide area network (WAN)), or a combination thereof.

The client machines 202A-202N may be wireless terminals (e.g., smartphones, etc.), personal computers (PC), laptops, tablet computers, or any other computing or communication devices. The client machines 202A-202N may run an operating system (OS) that manages hardware and software of the client machines 202A-202N. A browser (not shown) may run on the client machines (e.g., on the OS of the client machines). The browser may be a web browser that can render web pages served by a web server (e.g., web server 240 hosted by server machine 215, etc.). The client machines 202A-202N may also upload images via the browser to the web server for inclusion in web pages, archival storage, and so forth. It should be noted that in some implementations, content may be downloaded and presented to users via native applications running on client machines 202A-202N, either in addition to, or instead of, via web pages in a browser.

Server machine 215 may be a rackmount server, a router computer, a personal computer, a portable digital assistant, a mobile phone, a laptop computer, a tablet computer, a camera, a video camera, a netbook, a desktop computer, a media center, or any combination of the above. Server machine 215 includes a web server 240 and a web page manager 225. In alternative implementations, the web server 240 and web page manager 225 may run on different machines.

Image store 220 is a persistent storage that is capable of storing images (e.g., archived images, images that are embedded in web pages, etc.), as well as data structures to tag, organize, and index the images. Image store 220 may be hosted by one or more storage devices, such as main memory, magnetic or optical storage based disks, tapes or hard drives, NAS, SAN, and so forth. In some implementations, image store 220 may be a network-attached file server, while in other embodiments image store 220 may be some other type of persistent storage such as an object-oriented database, a relational database, and so forth, that may be hosted by the server machine 215 or one or more different machines coupled to the server machine 215 via the network 204. The images stored in the image store 220 may include user-generated images that are uploaded by client machines, as well as images provided by service providers such as news organizations, publishers, libraries and so on. In some implementations, image store 220 may be provided by a third-party service, while in some other implementations image store 220 may be maintained by the same entity maintaining server machine 215.

Web page store 230 is a persistent storage that is capable of storing web pages for serving to clients, as well as data structures to tag, organize, and index the web pages. Web page store 230 may be hosted by one or more storage devices, such as main memory, magnetic or optical storage based disks, tapes or hard drives, NAS, SAN, and so forth. In some implementations, web page store 230 may be a network-attached file server, while in other embodiments web page store 230 may be some other type of persistent storage such as an object-oriented database, a relational database, and so forth, that may be hosted by the server machine 215 or one or more different machines coupled to the server machine 215 via the network 204. The web pages stored in the web page store 230 may have embedded content (e.g., images in image store 220, images stored elsewhere on the Internet, streaming video (e.g., video clips), streaming music (e.g., audio clips) or other digital content) that is generated by users and uploaded by client machines, provided by news organizations, etc.

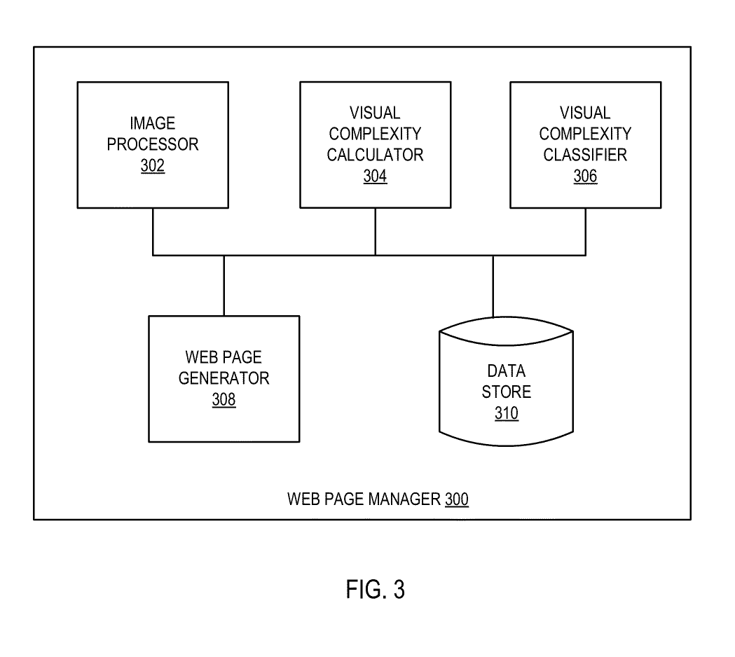

In accordance with some implementations, web page manager 225 is capable of storing uploaded images in image store 220, of indexing the images in image store 220, of performing image processing algorithms on images (e.g., filtering, anti-aliasing, line detection, etc.), of extracting features (e.g., color, texture, intensity, etc.) from images to generate feature vectors, of determining a measure of visual complexity of an image, and of generating web pages that may include user-provided images and storing the web pages in web page store 230. An implementation of web page manager 225 is described in detail below and with respect to FIG. 3.

FIG. 3 is a block diagram of one implementation of a web page manager. The web page manager 300 may be the same as the web page manager 225 of FIG. 2 and may include an image processor 302, a visual complexity calculator 304, a visual complexity classifier 306, a web page generator 308, and a data store 310. The components can be combined together or separated in further components, according to a particular implementation. It should be noted that in some implementations, various components of web page manager 300 may run on separate machines.

The data store 310 may be the same as web page store 230, or image store 220, or both, or may be a different data store (e.g., a temporary buffer or a permanent data store) to hold one or more images (e.g., to be stored in image store 220, to be embedded in web pages, to be processed, etc.), one or more data structures for indexing images in image store 220, one or more web pages (e.g., to be stored in web page store 230, to be served to clients, etc.), one or more data structures for indexing web pages in web page store 230, feature vectors associated with images, or some combination of these data. Data store 310 may be hosted by one or more storage devices, such as main memory, magnetic or optical storage based disks, tapes or hard drives, and so forth. In one aspect, the web page manager 300 notifies users of the types of information that are collected and stored in the data store 310, and in the instance where a user consents to the use of such data, the data may be used for training a classifier to assess the visual complexity of other images that are provided by the user or by other users.

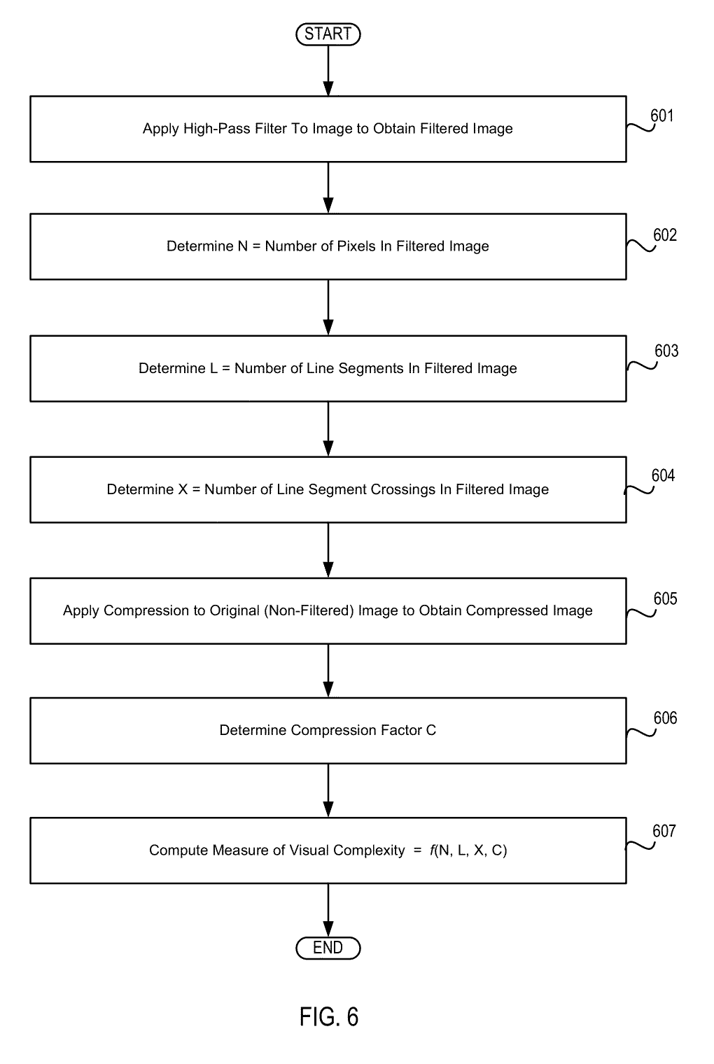

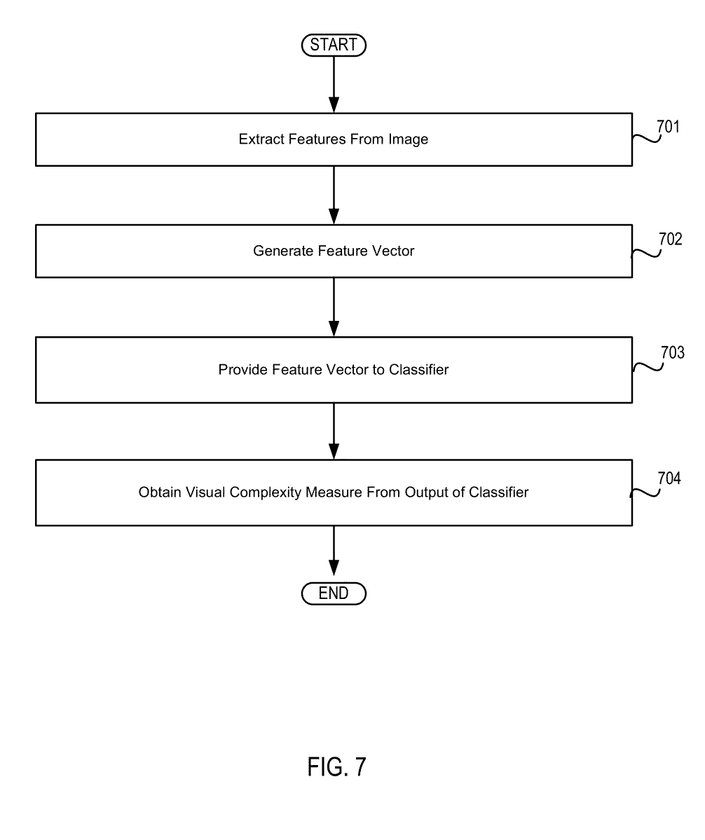

The image processor 302 is capable of image processing functions such as filtering, line detection, anti-aliasing, compression, etc., and of extracting features of images (e.g., color, texture, intensity, etc.) using one or more techniques such as principal components analysis, semidefinite embeddings, Isomaps, partial least squares, and so forth. Some operations of image processor 302 are described in more detail below with respect to FIGS. 6 and 7.

The visual complexity calculator 304 is capable of computing a measure of visual complexity of an image based on properties of the image obtained by image processor 302. Some operations of visual complexity calculator 304 are described in more detail below with respect to FIG. 6.

The visual complexity classifier 306 is a classifier (e.g., support vector machine [SVM], AdaBoost, neural network, decision tree, etc.) that accepts as input a feature vector based on features (e.g., color, texture, intensity, etc.) extracted from an image by image processor 302, and that outputs a score (e.g., a real number between 0 and 1 inclusive, etc.) indicating how visually complex the image is. In one implementation, visual complexity classifier 306 is trained on a set of positive examples that may include feature vectors for images known to be visually complex (e.g., as verified by a human, etc.), and on a set of negative examples that may include feature vectors for images that are known not to be visually complex. Some operations of visual complexity classifier 306 are described in more detail below with respect to FIG. 7.

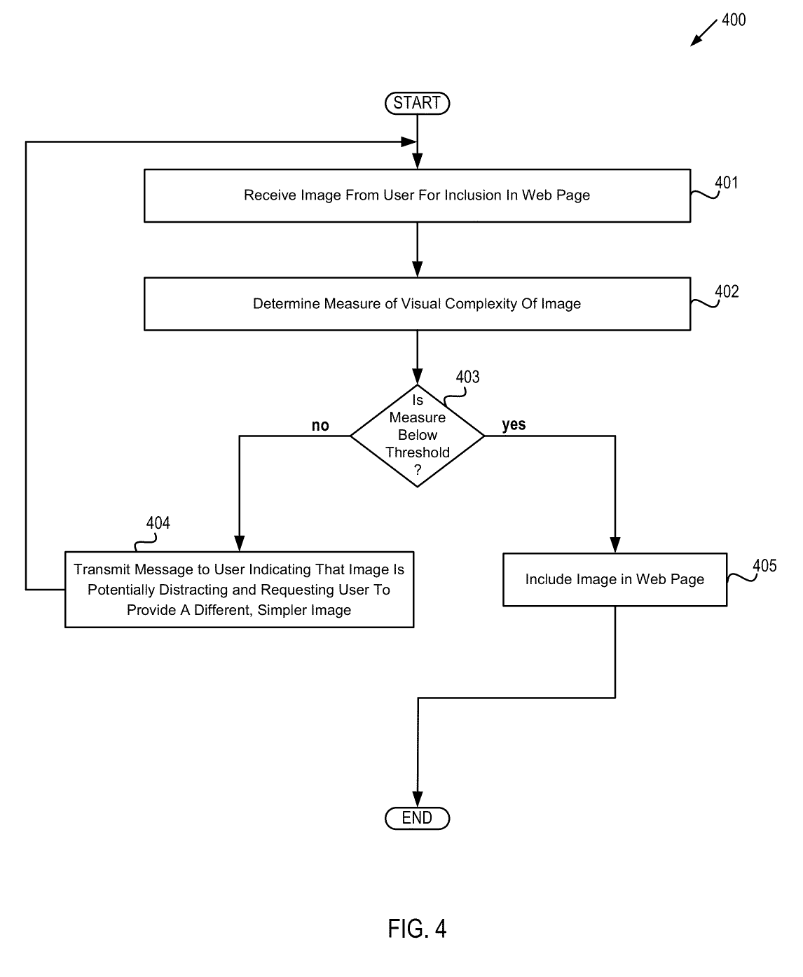

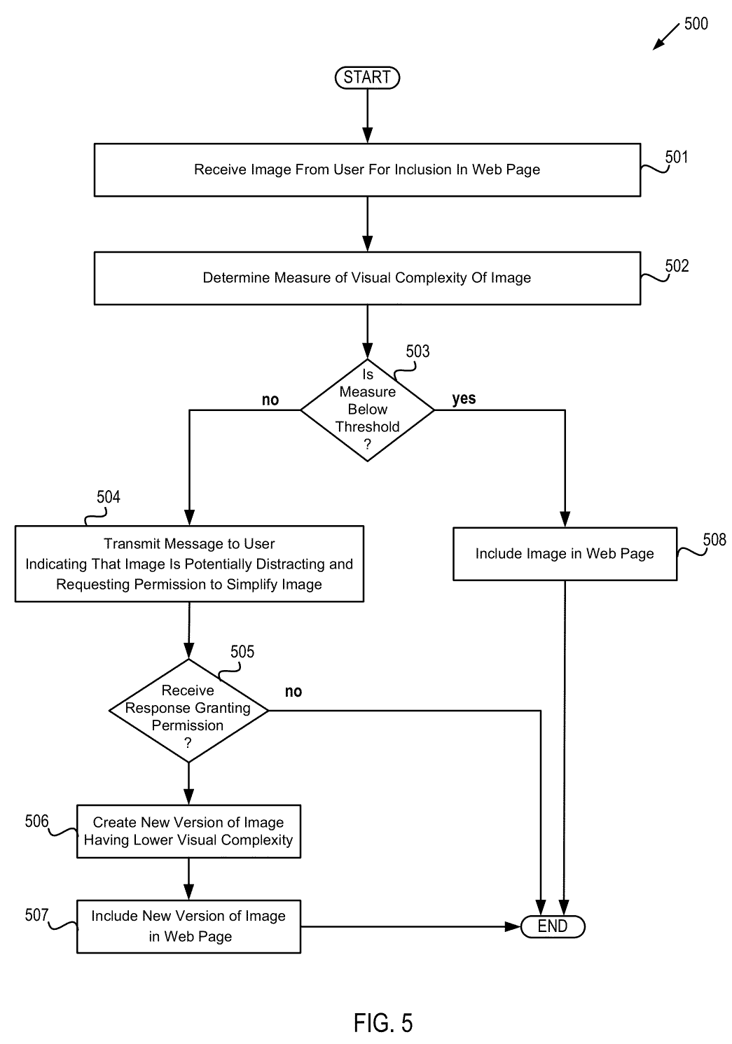

The web page generator 308 generates web pages that may include images provided by users, or simplified version of images generated by image processor 302. In one implementation, web page generator 308 uses a browser renderer (e.g., WebKit, etc.) to generate web pages based on Hypertext Transfer Markup Language (HTML) files, content templates (e.g., eXtensible Markup Language [XML] templates, etc.), formatting templates (e.g., Cascading Style Sheets [CSS], etc.), metadata associated with user-provided images, and so forth. As described in detail below with respect to FIGS. 4 and 5, in some embodiments, web page generator 308 also generates web pages that request users to provide different images, or to grant permission for the system to simplify the images and include the simplified images in web pages.

FIG. 4 depicts a flow diagram of aspects of a first example method 400 for detecting and handling when a user-provided image may be too distracting for inclusion in a web page. The method is performed by processing logic that may comprise hardware (circuitry, dedicated logic, etc.), software (such as is run on a general purpose computer system or a dedicated machine), or a combination of both. In one implementation, the method is performed by the server machine 215 of FIG. 2, while in some other implementations, one or more blocks of FIG. 4 are performed by another machine. It should be noted that in some implementations, the user-provided image may comprise one or more clickable regions (e.g., a region that acts as a hypertext link, etc.).

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 401, an image is received from a user for inclusion in a web page. The image may be intended as a background image, or to be placed in a particular area of the foreground of the web page. In accordance with one aspect, the image is received by web server 240.

At block 402, a measure of visual complexity of the image received at block 402 is determined. An implementation of a first example method for performing block 402 is described in detail below with respect to FIG. 6, and an implementation of a second example method for performing block 402 is described in detail below with respect to FIG. 7.

Block 403 compares the measure of visual complexity determined at block 402 to a threshold. If the measure is not below the threshold, execution proceeds to block 404, otherwise execution continues at block 405. In accordance with one aspect, block 403 is performed by web page manager 225.

At block 404, a message is transmitted to the user who provided the image. The message indicates that the image is potentially distracting to viewers of the web page, and requests that the user provide a different, simpler image for inclusion in the web page. In accordance with one aspect, the message is embedded in a web page by web page generator 308 of web page manager 225 and transmitted by web server 240.

After block 404, execution continues back at block 401.

At block 405, the image received at block 401 is included in the web page, and any browser requests for the web page will receive the web page with the image received at block 401 embedded in the page. In accordance with one aspect, block 405 is performed by web page generator 308 of web page manager 225.

FIG. 5 depicts a flow diagram of aspects of a second example method 500 for detecting and handling when a user-provided image may be too distracting for inclusion in a web page. The method is performed by processing logic that may comprise hardware (circuitry, dedicated logic, etc.), software (such as is run on a general purpose computer system or a dedicated machine), or a combination of both. In one implementation, the method is performed by the server machine 215 of FIG. 2, while in some other implementations, one or more blocks of FIG. 5 are performed by another machine.

At block 501, an image is received from a user for inclusion in a web page. The image may be intended as a background image, or to be placed in a particular area of the foreground of the web page. In accordance with one aspect, the image is received by web server 240.

At block 502, a measure of visual complexity of the image received at block 502 is determined. An implementation of a first method for performing block 502 is described in detail below with respect to FIG. 6, and an implementation of a second method for performing block 502 is described in detail below with respect to FIG. 7.

Block 503 compares the measure of visual complexity determined at block 502 to a threshold. If the measure is not below the threshold, execution proceeds to block 504, otherwise execution continues at block 508. In accordance with one aspect, block 503 is performed by web page manager 225.

At block 504, a message is transmitted to the user who provided the image. The message indicates that the image is potentially distracting to viewers of the web page, and requests permission from the user to simplify the image. In accordance with one aspect, the message is embedded in a web page by web page generator 308 of web page manager 225 and transmitted by web server 240.

At block 505, a response from the user granting permission to simplify the image is received. In accordance with one aspect, the response is received by web server 240.

At block 506, a new version of the image having lower visual complexity is generated. In accordance with one aspect, the simplified image is generated from the original image by image processor 302 (e.g., by applying anti-aliasing to the original image, by applying a low-pass filter to the original image, by removing line segments from the image, etc.). At block 507, the new, simplified version of the image is included in a web page. In accordance with one aspect, block 507 is performed by web page generator 308 of web page manager 225.

At block 508, the image received at block 501 is included in the web page, and any browser requests for the web page will receive the web page with the image received at block 501 embedded in the page. In accordance with one aspect, block 508 is performed by web page generator 308 of web page manager 225.

FIG. 6 depicts a flow diagram of aspects of a first method for determining a measure of visual complexity of an image. The method is performed by processing logic that may comprise hardware (circuitry, dedicated logic, etc.), software (such as is run on a general purpose computer system or a dedicated machine), or a combination of both. In one implementation, FIG. 6 is performed by web page manager 225.

At block 601, a high-pass filter is applied to an image to obtain a filtered image. In accordance with one aspect, block 601 is performed by image processor 302.

At block 602, the number of pixels in the filtered image, N, is determined. In general, the greater the number of pixels that are in the filtered image (i.e., that are not removed from the image by the high-pass filter), the fewer the number of sharp contrasts between neighboring pixels of the original image, and, in accordance with one aspect, the simpler the image will be considered to be. In accordance with one aspect, block 602 is performed by image processor 302.

At block 603, the number of line segments in the filtered image, L, is determined. In accordance with one aspect, block 603 is performed by image processor 302 via one or more line detection algorithms. It should be noted that in some alternative implementations, the number of line segments may be determined via processing of the original image, rather than the filtered image.

At block 604, the number of line segment crossings in the filter image, X, is determined. In accordance with one aspect, block 604 is performed by image processor 302 via one or more algorithms for detecting line intersections within a bounded rectangle. It should be noted that in some alternative implementations, the number of line segment crossings may be determined via processing of the original image, rather than the filtered image.

At block 605, compression is applied to the original, non-filtered image to obtain a compressed image. In accordance with one aspect, block 605 is performed by image processor 302 via one or more compression algorithms (e.g., run-length encoding, a discrete cosine transform [DCT] such as JPEG, etc.).

At block 606, a compression factor C is determined based on the size of the original image and the size of the compressed image. In accordance with one aspect, compression factor C is computed as:

$$C = \frac{size ( originalFile ) - size ( compressedFile )}{size ( originalFile )}$$

such that 0≦C<1 (e.g., C=0.2 represents 20% compression, C=0.45 represents 45% compression, etc.), and the greater the compression factor, the simpler the image will be considered to be.

At block 607, a measure of visual complexity is computed based on the number of pixels N in the filtered image, the number of line segments L, the number of line segment crossings X, and the compression factor C. In accordance with one aspect, the measure of visual complexity is computed as a function f, where f is monotonically decreasing with respect to N (i.e., the more pixels in the filtered image, the lower the measure of visual complexity), monotonically increasing with respect to L and X (i.e., the more line segments and the more line segment crossings, the greater the measure of visual complexity), and monotonically decreasing with respect to C (i.e., the greater the compression, the lower the measure of visual complexity). It should be noted that in some implementations, the measure computed by function f may be normalized to a number between 0 and 1 inclusive, where 0 indicates minimum visual complexity (e.g., a blank image) and 1 indicates maximum visual complexity. In accordance with one aspect, block 607 is performed by visual complexity calculator 304.

FIG. 7 depicts a flow diagram of aspects of a second method for determining a measure of visual complexity of an image. The method is performed by processing logic that may comprise hardware (circuitry, dedicated logic, etc.), software (such as is run on a general purpose computer system or a dedicated machine), or a combination of both. In one implementation, FIG. 7 is performed by web page manager 225.

At block 701, one or more features (e.g., color, texture, intensity) are extracted from an image, and at block 702, a feature vector is generated from the feature(s). In accordance with one aspect, blocks 701 and 702 are performed by image processor 302.

At block 703, the feature vector is provided to a classifier (e.g., visual complexity classifier 306 of web page manager 225) that has been trained to quantify the visual complexity of images. In accordance with one aspect, the classifier may be a support vector machine [SVM], AdaBoost, a neural network, a decision tree, etc., and may output a score based on the feature vector that reflects how visually complex the image is. In one implementation, the classifier is trained on a set of positive examples that may include feature vectors for images known to be visually complex (e.g., as verified by a human, etc.), and on a set of negative examples that may include feature vectors for images that are known not to be visually complex.

At block 703, a measure of visual complexity is obtained from the score output by the classifier. In some implementations, the measure may be obtained by applying a function to the score (e.g., a normalization function, a linear expansion function, a non-linear squashing function, etc.), while in some other implementations, the measure may be the score itself.

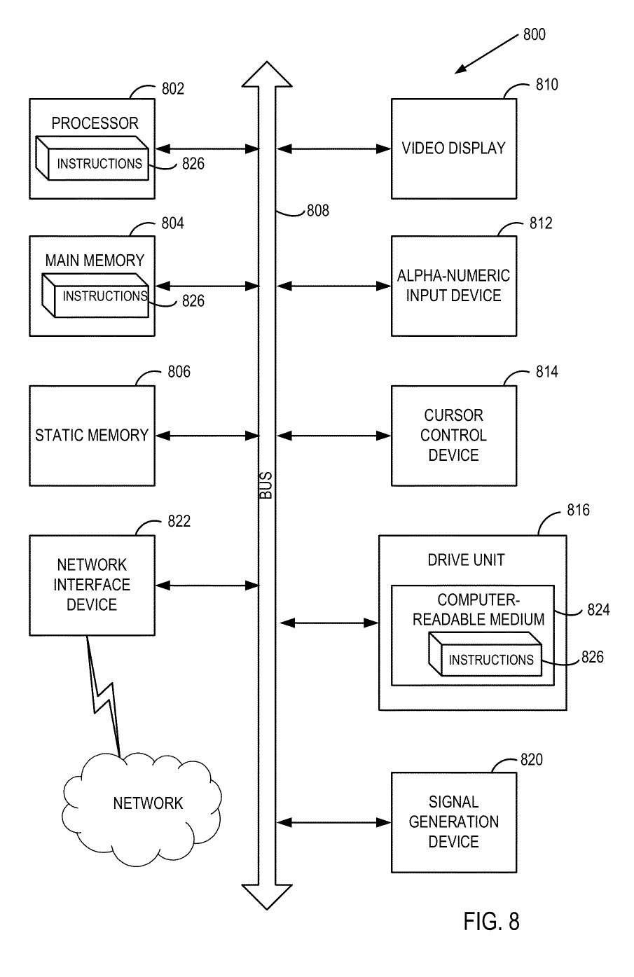

FIG. 8 illustrates an exemplary computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 includes a processing system (processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 816, which communicate with each other via a bus 808.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 may also be one or more special-purpose processing devices such as an application specific integrated circuit (ASIC), a field programmable gate array (FPGA), a digital signal processor (DSP), network processor, or the like. The processor 802 is configured to execute instructions 826 for performing the operations and steps discussed herein.

The computer system 800 may further include a network interface device 822. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker).

The data storage device 816 may include a computer-readable medium 824 on which is stored one or more sets of instructions 826 (e.g., instructions executed by web page manager 225, etc.) embodying any one or more of the methodologies or functions described herein. Instructions 826 may also reside, completely or at least partially, within the main memory 804 and/or within the processor 802 during execution thereof by the computer system 800, the main memory 804 and the processor 802 also constituting computer-readable media. Instructions 826 may further be transmitted or received over a network via the network interface device 822.

While the computer-readable storage medium 824 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “creating,” “including,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. A method comprising:
identifying an image to be included in a user interface;
determining, by a computer system, a measure of visual complexity of the image, wherein the measure of visual complexity of the image is a numeric value that indicates distraction to a viewer of the user interface by the visual complexity of the image; and
including the image in the user interface when the numeric value is less than a threshold.

2. The method of claim 1 further comprising receiving the image from a user for inclusion in the user interface.

3. The method of claim 2 wherein the image is to be included in the user interface as a background image.

4. The method of claim 2 wherein when the numeric value is at least as great as the threshold, the method further comprises:
creating a new version of the image with a smaller measure of visual complexity; and
including the new version of the image in the user interface instead of the image.

5. The method of claim 4 wherein when the numeric value is at least as great as the threshold, the method further comprises generating a request for permission by the user to create the new version of the image.

6. The method of claim 2 wherein when the numeric value is at least as great as the threshold, the method further comprises generating a request for a different image from the user.

7. The method of claim 1 wherein the numeric value is based on a difference in intensity between a first pixel of the image and a second pixel of the image neighboring the first pixel.

8. The method of claim 1 wherein the measure of visual complexity is based on a number of line segments in the image.

9. An apparatus comprising:
a memory to store an image to be included in a user interface; and
a processor to:
determine a measure of visual complexity of the image, wherein the measure of visual complexity of the image is a numeric value that indicates of distraction to a viewer of the user interface by the visual complexity of the image, and
include the image in the user interface only when the numeric value is less than a threshold.

10. The apparatus of claim 9 wherein the image is provided by a user for inclusion in the user interface.

11. The apparatus of claim 10 wherein the image is to be included in the user interface as a background image.

12. The apparatus of claim 10 wherein when the numeric value is at least as great as the threshold, the processor is further to:
create a new version of the image with a smaller measure of visual complexity; and
include the new version of the image in the page user interface instead of the image.

13. The apparatus of claim 12 wherein when the numeric value is at least as great as the threshold, the processor is further to generate a request for permission by the user to create the new version of the image.

14. The apparatus of claim 10 wherein when the numeric value is at least as great as the threshold, the processor is further to generate a request for a different image from the user.

15. The apparatus of claim 9 wherein the numeric value is based on a number of line segment intersections in the image.

16. The apparatus of claim 9 wherein the image comprises a clickable region.

17. A non-transitory computer-readable storage medium having instructions stored therein, which when executed, cause a computer system to perform operations comprising:
identifying an image to be included in a user interface;
determining, by the computer system, a measure of visual complexity of the image, wherein the measure of visual complexity of the image is a numeric value that indicates distraction to a viewer of the user interface by the visual complexity of the image; and
including the image in the user interface when the numeric value is less than a threshold.

18. The non-transitory computer-readable storage medium of claim 17, wherein the operations further comprise receiving the image from a user for inclusion in the user interface.

19. The non-transitory computer-readable storage medium of claim 17, wherein the image is to be included in the user interface as a background image.

20. The non-transitory computer-readable storage medium of claim 17, wherein when the numeric value is at least as great as the threshold, the operations further comprise:
creating a new version of the image with a smaller measure of visual complexity; and
including the new version of the image in the user interface instead of the image.

21. The non-transitory computer-readable storage medium of claim 20, wherein when the numeric value is at least as great as the threshold, the operations further comprise generating a request for permission by a user to create the new version of the image.

22. The non-transitory computer-readable storage medium of claim 17, wherein when the numeric value is at least as great as the threshold, the method further comprises generating a request for a different image from a user.

23. The non-transitory computer-readable storage medium of claim 17, wherein the numeric value is based on a compression metric for the image.

24. The non-transitory computer-readable storage medium of claim 17, wherein the measure of visual complexity of the image is determined by a classifier that is trained on positive and negative examples of visually-complex images.
